(19) United States
(12) Patent Application Publication
(10) Pub. No.: US 2014/0019762 A1
(43) Pub. Date: Jan. 16, 2014

(54) Method, Process and System for Digitally Signing an Object

(71) Applicant: Jason Sabin, Lehi, UT (US)

(72) Inventor: Jason Sabin, Lehi, UT (US)

(73) Assignee: DIGICERT, INC., Lindon, UT (US)

(21) Appl. No.: 13/545,557

(22) Filed: Jul. 10, 2012

(51) Int. Cl. H04L 9/32

(52) U.S. Cl. 713/176

(57) ABSTRACT

The invention comprises a method of auditing an object signing by creating security events throughout the signature process, including a security event that captures the identity of the signer and any anomalies associated with the signing process. The signature process may include multi-factor authentication, a policy engine that establishes the signer's authority and rights, and compliance checks that ensure the object's readiness for signature. The digital certificate used to sign the object may be stored on the cloud, locally, remotely, or on a hardware token.

### BACKGROUND

Object signing is used worldwide to establish trust in a company's products. In fact, many companies sign all major and minor software products in an attempt to eliminate potential problems related to downloading, installing, and using files. Signed objects include documents, software applications, applets, PDF files, and even uncompiled code.

Object signing usually utilizes a digital certificate provided by a trusted certification authority to establish an object's online trust. The value of the object signing and the meaning associated with the signing varies depending on the relevant market and purpose, but, in general, the signature process acts as some sort of representation by the signer to the end-user. Depending on the use, the representation may include that the object is free from malware, that the object has not been modified since signing, or that the object has undergone a certain level of testing or vetting prior to signing.

This representation is largely illusory since signing companies lack a method or process to ensure the integrity of the signature process. Currently, companies lack an auditing process that verifies the signing key was not misused and that the signature process was authorized. This lack of security during signing undermines the authentication required for these companies to receive a digital certificate and makes this step in the process a target for attacks.

### SUMMARY OF THE INVENTION

The invention teaches a method of auditing an object signing event, using security events and a process and system for signing objects in a manner that is auditable. The security events are sent to local SIEM systems, local notification systems, or the CA's auditing system for review and storage.

Security events may include a timestamp of important events, a photo or video of the signing process, information about the signer, a sample of the object being signed, and important events that occur during the signing process.

Signing uses a digital certificate that is stored locally, on the cloud, or on a hardware token. Signing events may occur when the hardware token is inserted into or removed from the signing server.

The signing process may include a policy engine that establishes or limits the signer's authority to sign objects and compliance checks that evaluate whether an object is ready for signature.

### BRIEF DESCRIPTION OF THE FIGURES

FIG. 1 is a flowchart of the process used to digitally sign an object.

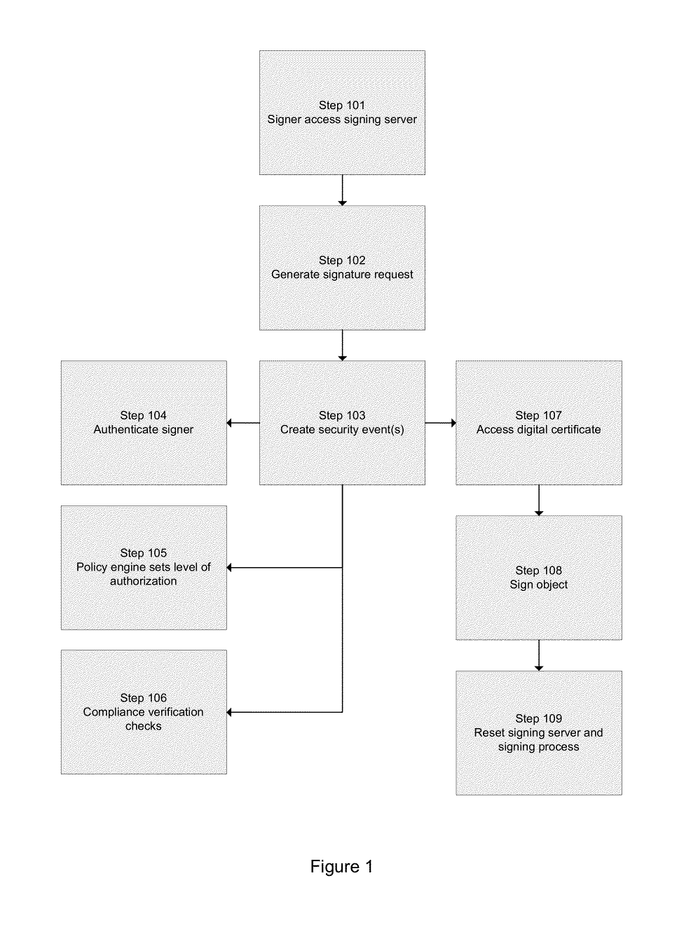

FIG. 2 is an illustration of the components used to digitally sign an object.

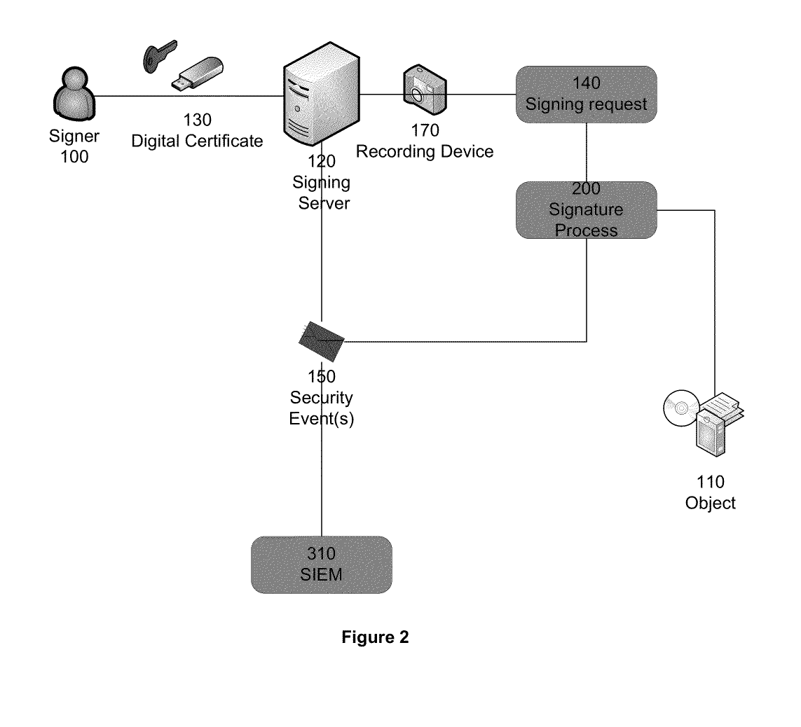

FIG. 3 is an example implementation of the invention.

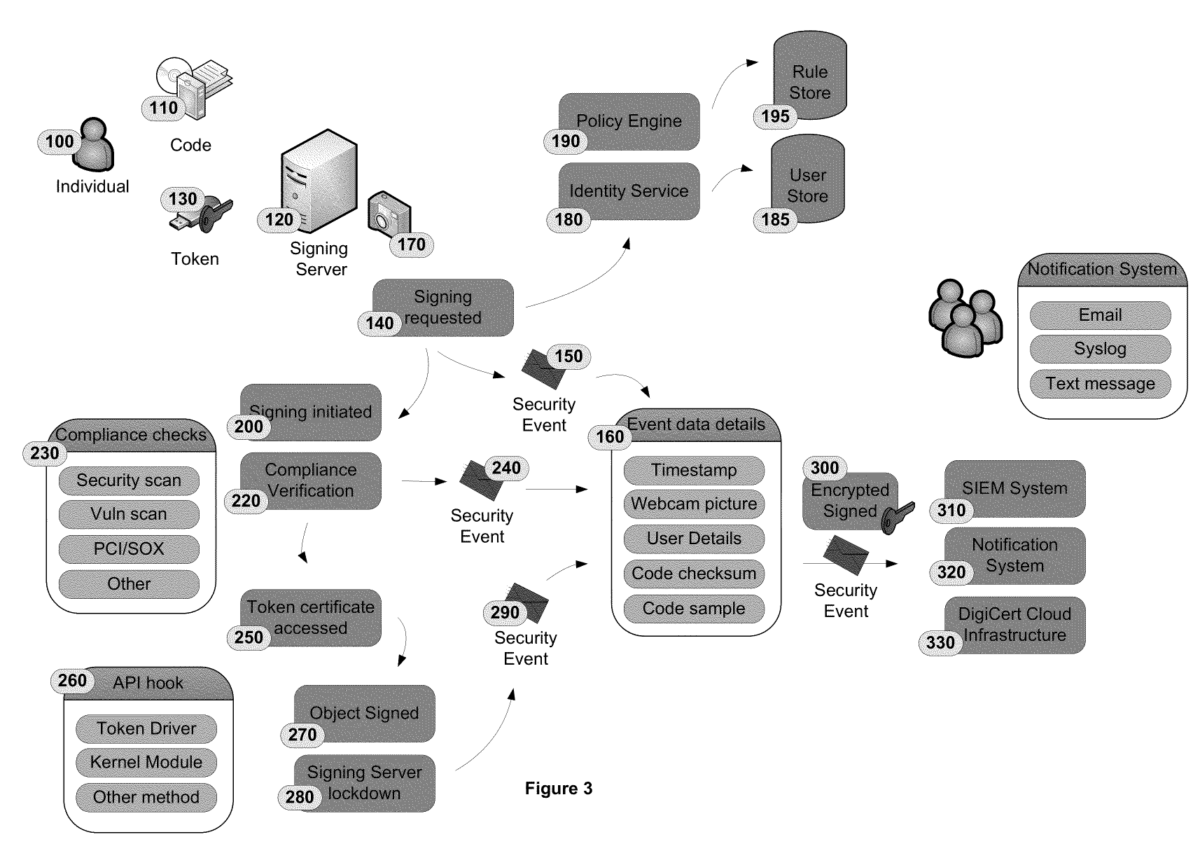

### DESCRIPTION OF INVENTION

Object signing means digitally signing code, documents, drivers, hardware devices, or other computer objects (each of which is an object) using a digital certificate 130, preferably using an EV Code Signing Certificate that is stored on a FIPS compliant hardware token.

A signing server 120 means a computer or terminal that will perform or access the signature process. The actual signature process may occur and the digital certificate may be located on the signing server or elsewhere, including on the cloud, the signing server, a hardware token, or a remote device that is not necessarily under the signer's control.

An object signature request 140 is a request by the signing server to start the signing or auditing process. The object signature request can be initiated automatically when the hardware token is inserted into the signing server, by an application on the signing server, a web service, or through a cloud-based service.

A signer 100 is an entity (natural or legal) that initiates the signature process on a signing server.

A security event 150 is data containing information about a decision or action taken during the signature process. This data may include a timestamp of important steps, a webcam picture or video of the individual performing the object signing using a camera or other photographic/recording device 170, information about the user initiating the signing request, a sample of the object being signed (such as selection from the file for a document signing or part of the source code for application signing), code checksums, and other important information about the signing process. Each security event may include unique data or repeat some or all off the data of a previously issued security event. Security events are typically sent to a security information and management system and securely stored for future review.

In step 101, the signer 100 accesses the signing server 120. If the signer is using a digital certificate on a hardware token 130 or using a hardware token as its authentication mechanisms, the signer may be required to insert the hardware token into the signing server before access is granted. The signing server may generate a security event 150 when the hardware token is inserted (or removed) and may initiate the signature process automatically if the hardware token is detected.

In step 102, the signing server 120 generates an signature request 140 that starts the signature process 200.

In step 103, either the signature process or the object signature request creates a security event 150 to record details of the signature process. The security event should be encrypted and securely stored once created to prevent tampering. If the signing server or signature process requires multiple authentication, a separate security event can occur during each authentication to capture information related to the different authenticated entities.

The signature process may create a single security event that updates periodically with information throughout the signature process or create security events for each important step in the signature process. Multiple security events provide auditors a complete picture of the signature process and multiple alerts about potential security issues or technical problems. Having multiple security events capture the process and images of the signer allow an auditor to validate the signer's credentials during each step.

To prevent a compromise or data tampering, the security events may be sent and stored in multiple locations, including a SIEM or Security Information Event Management system 310, a legacy notification system 320 which could include email, text message, or syslog events, the signer's auditor or manager, and the Certification Authority 340 that provided the signing certificate. A signer, auditor, or the Certification Authority can review these events to ensure the company's compliance with a signing policy or agreement. The events could also be used to monitor the company's release schedule or ensure that the proper separation of roles is occurring during the signature process.

In step 104, the signature process requires the signer to validate their identity. Note that step 104 may actually occur prior to step 103. The signer's identity is validated using a local or remote identity service 180 that may include single or multi-factor authentication, Federation Identity such as SAML, WS-Federation, or other federation protocols, or any other known method of validating the signer's identity.

In step 105, if desired, a policy engine 190 sets the signer's level of access in the signature process based on a stored set of rules 195. This access may dictate the types of object signing the signer can perform, the software packages or devices the signer is authorized to sign, the tokens and authentication mechanism required to complete the signature process, and the compliance checks that the system performs during the signature process. These policies are generally set by either an administrator of the signing server or the signature process but may be set by a certification authority 340 using configuration utility or by supplying the policy engine.

In step 106, a compliance verification process performs compliance checks (if any) to evaluate whether the object is ready for signature. Compliance checks 230 may include security scans, malware scans, vulnerability scans, PCI/SOX, an evaluation of the hardware's performance, or other compliance scans on the object. The compliance check can be presented as a checklist to the signer or a second authenticator who verifies that each step is complete or by having the signing server complete the checks. A more robust system could access a compliance server that performs the compliance check and reports back the results during the signature process.

In step 107, the signature process 200 accesses the digital certificate 130. If the digital certificate is stored on a hardware token, on the cloud, or in the Certification Authority's systems, the application accesses the certificate via an API hook 260.

In step 108, the object 110 is signed using the digital certificate 130.

In step 109, additional information about the signature process results and signed object is stored in a designated database and the server resets for the next signing event. Generating and storing this information may include issuing another security event that specifies anomalies detected in the signed object, anomalies detected during the signature process, the status of the signature process, the success of the signature process, and information about how long the process took. This end result information can be used by auditors to detect whether there was a compromise of the signing event and the signer or certification authority to evaluate how to increase the signature process's efficiency.

What is claimed is:

1. A method of auditing a signature process comprising creating a security event during the signature process where the security event comprises information about an event that occurs during the signature process.

2. A method according to claim 1 where the security event comprises of compliance verification checks.

3. A method according to claim 1 where the security event is created when a hardware token is inserted into a signing server.

4. A method according to claim 3 where the signature process is initiated when the hardware token is inserted into a signing server.

5. A method according to claim 1 further comprising signing an object using a digital certificate.

6. A method according to claim 5 where the digital certificate is stored on a hardware token.

7. A method according to claim 5 where the digital certificate is stored on the cloud.

8. A method according to claim 1 where the security event comprises a timestamp.

9. A method according to claim 1 where the security event comprises a picture of the signer.

10. A method according to claim 1 where the security event comprises a sample of the object being signed.

11. A method according to claim 1 where the security event is periodically updated during the signature process.

12. A method according to claim 1 where multiple security events are created during the signature process.

13. A method according to claim 1 where the security event is sent to a certification authority.

14. A method according to claim 1 where the security event is sent to an auditor.

15. A method according to claim 1 further comprising compliance checks that evaluate an object's readiness for signing.

16. A method according to claim 1 where the security event comprises anomalies detected during the signature process.

17. A process for signing objects comprising:
Authenticating a signer to a signing server;
Creating at least one security event; and
Signing an object using a digital certificate.

18. A process according to claim 17 where the signer is authenticated using multi-factor authentication.

19. A process according to claim 17 further comprising having a policy engine set the signer's level of access based on a stored set of rules.

20. A process according to claim 19 where the level of access is used to determine the objects that the signer is authorized to sign.

21. A process according to claim 19 where the level of access determines what authentication mechanisms are required before signing the object.

22. A process according to claim 19 where the rules are set by a certification authority.

23. A process according to claim 17 further comprising evaluating the object's readiness for signature using compliance checks.

24. A process according to claim 17 where the digital certificate is stored on the cloud.

25. A system for signing an object comprising:
A signing server;
A digital certificate;
An object;
A security event; and
A signature process.

26. A system according to claim 25 further comprising at least one authentication mechanism.

27. A system according to claim 25 where the security event includes information about the signature process.

28. A system according to claim 27 where the security event includes anomalies detected during the signature process.

29. A system according to claim 27 where the security event includes information about the object.

30. A system according to claim 25 where the digital certificate is stored on the cloud.

31. A system according to claim 25 where the digital certificate is stored on a hardware token.

32. A system according to claim 25 further comprising at least one compliance check.

33. A system according to claim 25 further comprising a policy engine.

34. A system according to claim 25 further comprising a camera.
